(19) United States
(12) Patent Application Publication
(10) Pub. No.: US 2007/0035476 A1
(43) Pub. Date: Feb. 15, 2007

(54) Method of driving plasma display panel and plasma display device driven using the method

(76) Inventors: Dong-Young Lee, Suwon-si (KR); Won-Ju Yi, Suwon-si (KR); Ho-Young Ahn, Suwon-si (KR); Kyoung-Doo Kang, Suwon-si (KR); Soo-Ho Park, Suwon-si (KR); Seok-Gyun Woo, Suwon-si (KR); Jae-Ik Kown, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/489,365

(22) Filed: Jul. 18, 2006

(30) Foreign Application Priority Data
Aug. 10, 2005 (KR) 10-2005-0073329

(51) Int. Cl. G09G 3/28

(52) U.S. Cl. 345/63

(57) ABSTRACT

A method of driving a plasma display panel (PDP) and a plasma display device driven by the method are disclosed. In one embodiment, a display image is represented by a plurality of unit frames, and each unit frame is divided into a plurality of sub-fields. Each of the sub-fields includes a reset period when all discharge cells are initialized, an address period when a discharge cell that is turned on or off is selected from all discharge cells, and a sustain period when a sustain discharge is performed for a discharge cell selected to be turned on in the address period according to gray-level weights allocated to each of the sub-fields. Furthermore, a rising ramp pulse and a falling ramp pulse are applied to the first electrode in the reset period. According to one embodiment of the invention, reset light generated by a reset discharge can be minimized in a reset period, and wall charges in discharge cells can be precisely controlled so that light-emitting efficiency is improved and the likelihood of a permanent afterimage being left on the display is reduced.

### CROSS-REFERENCE TO RELATED PATENT APPLICATION

This application claims the benefit of Korean Patent Application No. 10-2005-0073329, filed on Aug. 10, 2005, in the Korean Intellectual Property Office, the disclosure of which is incorporated herein in its entirety by reference. This application also relates to U.S. patent application (Attorney Docket Number: SDIYPL.068AUS) entitled “Method of driving plasma display panel and plasma display device driven using the method,” concurrently filed as this application, which is incorporated by reference.

### BACKGROUND OF THE INVENTION

1. Field of the Invention

The present invention relates to a plasma display panel (PDP), and more particularly, to a method of driving a PDP having a new structure that improves light-emitting efficiency and reduces the likelihood of a permanent afterimage, and a plasma display device driven using the method.

2. Description of the Related Technology

PDP devices have generally replaced conventional cathode ray tube (CRT) display devices. PDP devices provide a desired image using visible radiation generated by sealing a discharge gas, applying a discharge voltage between two panels of a PDP in which a plurality of electrodes are formed to generate vacuum ultraviolet radiation, and exciting a phosphor by the vacuum ultraviolet radiation in a predetermined pattern.

FIG. 1 is a partially exploded perspective view of a conventional three-electrode surface discharge type PDP 1. FIG. 2 is a cross-sectional view of the PDP of FIG. 1 taken along line II-II in FIG. 1.

Referring to FIGS. 1 and 2, the conventional PDP 1 has a first panel 110 and a second panel 120. The first panel 110 includes a front substrate 111, a dielectric layer 115 that covers scan electrode lines 112 and sustain electrode lines 113 at the rear of the first substrate 111, and a protection layer 116 that protects the first dielectric layer 115. The scan electrode lines 112 and sustain electrode lines 113 form a pair of sustain electrodes 114, and include bus electrodes 112a and 113a, and transparent electrodes 112b and 113b, respectively. The bus electrodes 112a and 113a are generally formed of a metal, and the transparent electrodes 112b and 113b are generally formed of a transparent and conductive material such as indium tin oxide (ITO) to increase a conductivity.

The second panel 120 includes a second substrate 121, a second dielectric layer 123 that is formed in a direction of the first substrate 111 at the front of the second substrate 121 to cover address electrode lines 122 that cross the scan electrode lines 112 and the sustain electrode lines 113. The second panel 120 also includes the address electrode lines 122, barrier ribs 124 that partition discharge cells Ce in a top surface of the second dielectric layer 123, a phosphor layer 125 formed in space partitioned by the barrier ribs 124, and a second protection layer 128 formed in the front of the phosphor layer 125 for protecting the phosphor layer 125. A discharge gas is injected in the discharge cells Ce, i.e., the space partitioned by the barrier ribs 124.

The conventional three-electrode surface discharge type PDP 1 illustrated in FIGS. 1 and 2 displays an image by dividing a frame into a plurality of sub fields, and classifying each of the sub fields as a reset period, an address period, and a sustain period. However, the conventional three-electrode surface discharge type PDP 1 has the following disadvantages:

First, a considerable amount of visible radiation emitted in the phosphor layer 128 (about 40%) is absorbed by at least one of i) the scan electrode lines 112 and ii) sustain electrode lines 113 that are arranged beneath the first substrate 110, iii) the first dielectric layer 115 covering the scan electrode lines 112 and sustain electrode lines 113, and iv) the first protection layer 116, thereby reducing light-emitting efficiency.

Second, when the conventional PDP 1 displays an image for a long time, the phosphor layer 128 is ion-sputtered due to charge particles of the discharge gas, thereby causing a permanent afterimage or long-time image retention.

### SUMMARY OF CERTAIN INVENTIVE ASPECTS

One aspect of the present invention provides i) a method of driving a plasma display panel (PDP) having a new structure that improves light-emitting efficiency and reduces the likelihood of a permanent afterimage, so that reset light generated by a reset discharge can be minimized in a reset period, and wall charges in discharge cells can be precisely controlled, and ii) a plasma display device driven by the method.

Another aspect of the present invention provides a method of driving a plasma display panel (PDP) including i) first and second substrates spaced apart from each other, ii) a barrier rib along with the first and second substrates partitioning discharge cells that are discharge spaces, iii) first and second electrodes extending to cross each other in the barrier rib, iv) a phosphor layer formed in the discharge cells, and v) a discharge gas in the discharge cells. In one embodiment, a display image is represented by a plurality of unit frames and each unit frame is divided into a plurality of sub-fields, and each of the sub-fields is divided into a reset period when all discharge cells are initialized, an address period when a discharge cell that is turned on or off is selected from all discharge cells, and a sustain period when a sustain discharge is performed for a discharge cell selected to be turned on in the address period according to gray-level weights allocated to each of the sub-fields. Furthermore, a rising pulse and a falling pulse are applied to the first electrode in the reset period in which the rising pulse and the falling pulse are ramp pulses.

In one embodiment, a bias voltage may be applied to the second electrode when the falling pulse is applied in the reset period, a scan pulse sequentially having a high level and a low level may be applied to the first electrode, and a display data signal may be applied to the second electrode in accordance with the scan pulse in the address period, and a sustain pulse alternately having a high level and a low level may be applied to the first electrode, and an intermediate level between the high level and the low level of the sustain pulse may be applied to the second electrode in the sustain period.

Another aspect of the present invention provides a method of driving a PDP including i) first and second substrates spaced apart from each other, ii) a barrier rib along with the first and second substrates partitioning discharge cells that are discharge spaces, iii) first and second electrodes extending in a direction in the barrier rib, iv) a third electrode extending to cross the first and second electrodes in the barrier rib, v) a phosphor layer formed in the discharge cells, and vi) a discharge gas in the discharge cells. In one embodiment, each unit frame used to express an image is divided into a plurality of sub-fields, and each of the sub-fields is divided into a reset period when all discharge cells are initialized, an address period when a discharge cell that is turned on or off is selected from all discharge cells, and a sustain period when a sustain discharge is performed for a discharge cell selected to be turned on in the address period according to gray-level weights allocated to each of the sub-fields. Furthermore, a rising pulse and a falling pulse are applied to the first electrode in the reset period in which the rising pulse and the falling pulse are ramp pulses.

In one embodiment, a bias voltage may be applied to the second electrode when the falling pulse is applied in the reset period, a scan pulse sequentially having a high level and a low level may be applied to the first electrode, a display data signal may be applied to the third electrode in accordance with the scan pulse, and a bias voltage may be applied to the second electrode in the address period, and a sustain pulse alternately having a high level and a low level may be applied to the first electrode and the second electrode, and an intermediate level between the high level and the low level of the sustain pulse may be applied to the third electrode in the sustain period.

Another aspect of the present invention provides a plasma display apparatus comprising: i) a PDP including first and second substrates spaced apart from each other, a barrier rib along with the first and second substrates partitioning discharge cells that are discharge spaces, first and second electrodes extending to cross each other in the barrier rib, a phosphor layer formed in the discharge cells, a discharge gas in the discharge cells, and ii) drivers applying a diving signal that is divided into reset, address, and sustain periods to each of the first and second electrodes to drive the PDP. In one embodiment, each unit frame is divided into a plurality of sub-fields, and each of the sub-fields is divided into the reset period when all discharge cells are initialized, the address period when a discharge cell that is turned on or off is selected from all discharge cells, and the sustain period when a sustain discharge is performed for a discharge cell selected to be turned on in the address period according to gray-level weights allocated to each of the sub-fields. Furthermore, the drivers a first driver that applies the driving signal to the first electrode, and a second driver that applies the driving signal to the second electrode, the first driver applies a rising pulse and a falling pulse to the first electrode in the reset period, in which the rising pulse and the falling pulse are ramp pulses.

In one embodiment, the second driver may apply a bias voltage to the second electrode when the first driver applies the falling pulse to the first electrode in the reset period, the first driver may apply a scan pulse sequentially having a high level and a low level to the first electrode, and the second driver may apply a display data signal to the second electrode in accordance with the scan pulse in the address period, and the first driver may apply a sustain pulse alternately having a high level and a low level to the first electrode, and the second driver may apply an intermediate level between the high level and the low level of the sustain pulse to the second electrode in the sustain period.

Another aspect of the present invention provides a plasma display apparatus comprising: i) a PDP including first and second substrates spaced apart from each other, a barrier rib along with the first and second substrates partitioning discharge cells that are discharge spaces, first and second electrodes extending in a direction in the barrier rib, a third electrode extending to cross the first and second electrodes in the barrier rib, a phosphor layer formed in the discharge cells, a discharge gas in the discharge cells, and ii) drivers applying a diving signal that is divided into reset, address, and sustain periods to each of the first, second, and third electrodes to drive the PDP. In one embodiment, each unit frame is divided into a plurality of sub-fields, and each of the sub-fields is divided into the reset period when all discharge cells are initialized, the address period when a discharge cell that is turned on or off is selected from all discharge cells, and the sustain period when a sustain discharge is performed for a discharge cell selected to be turned on in the address period according to gray-level weights allocated to each of the sub-fields. Furthermore, the drivers include a first driver that applies the driving signal to the first electrode, a second driver that applies the driving signal to the second electrode, and a third driver that applies the driving signal to the third electrode, the first driver applies a rising pulse and a falling pulse to the first electrode in the reset period, in which the rising pulse and the falling pulse are ramp pulses.

In one embodiment, the second driver may apply a bias voltage to the second electrode when the falling pulse is applied in the reset period, the first driver may apply a scan pulse sequentially having a high level and a low level to the first electrode, the third driver may apply a display data signal to the third electrode in accordance with the scan pulse, and the second driver applies a bias voltage to the second electrode in the address period, and the first and second drivers may apply a sustain pulse alternately having a high level and a low level to the first and second electrodes, respectively, and the third electrode may apply an intermediate level between the high level and the low level of the sustain pulse to the third electrode in the sustain period.

### BRIEF DESCRIPTION OF THE DRAWINGS

Embodiments of the present invention will be described with reference to the attached drawings.

FIG. 1 is a partially exploded perspective view of a conventional three-electrode surface discharge type plasma display panel (PDP).

FIG. 2 is a cross-sectional view of the PDP of FIG. 1 taken along line II-II in FIG. 1.

FIG. 3 is a perspective view of a PDP having improved light-emitting efficiency and reduced likelihood of a permanent afterimage, which uses a method of driving the PDP according to an embodiment of the present invention.

FIG. 4 is a cross-sectional view of the PDP of FIG. 3 taken along line IV-IV in FIG. 3.

FIG. 5 illustrates discharge cells and electrodes illustrated in FIGS. 3 and 4.

FIG. 6 is a timing diagram for explaining a method of driving the PDP illustrated in FIG. 3.

FIG. 7 is a block diagram of the PDP illustrated in FIG. 3 and a plasma display apparatus for driving the PDP according to an embodiment of the present invention.

FIG. 8 illustrates waveforms of a driving signal for driving the PDP illustrated in FIG. 3 according to an embodiment of the present invention.

FIG. 9 is a perspective view of a PDP having improved light-emitting efficiency and reduced likelihood of a permanent afterimage, which uses a method of driving the PDP according to another embodiment of the present invention.

FIG. 10 is a cross-sectional view of the PDP of FIG. 9 taken along line X-X in FIG. 9.

FIG. 11 illustrates discharge cells and electrodes illustrated in FIGS. 9 and 10.

FIG. 12 is a block diagram of the PDP illustrated in FIG. 9 and a plasma display apparatus for driving the PDP according to another embodiment of the present invention.

FIG. 13 illustrates waveforms of a driving signal for driving the PDP illustrated in FIG. 9 according to another embodiment of the present invention.

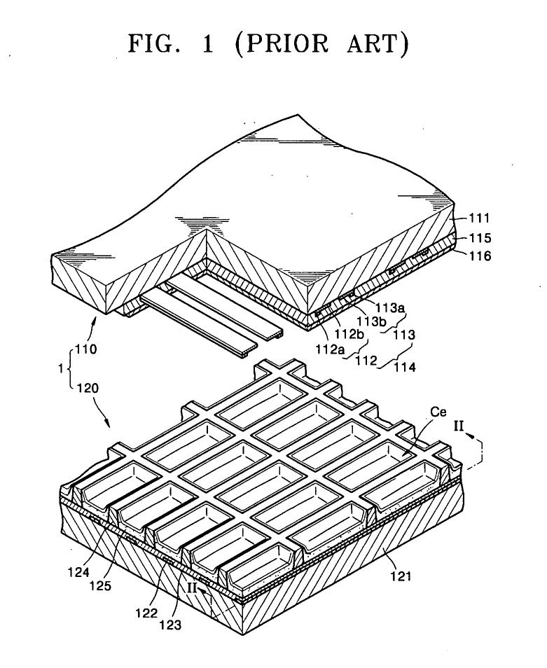

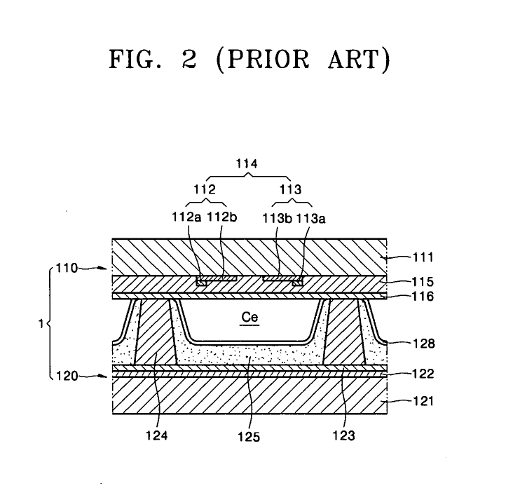

### DETAILED DESCRIPTION OF CERTAIN INVENTIVE EMBODIMENTS

Embodiments of the present invention will now be described more fully with reference to the accompanying drawings, in which exemplary embodiments of the invention are shown.

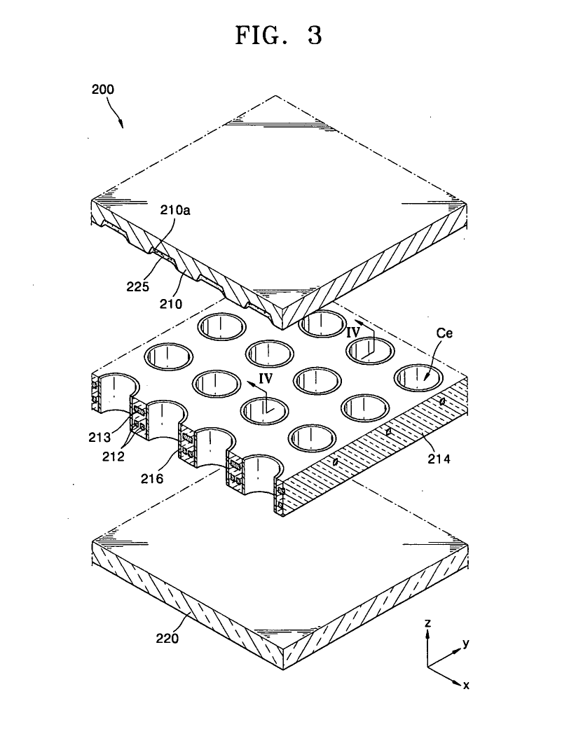

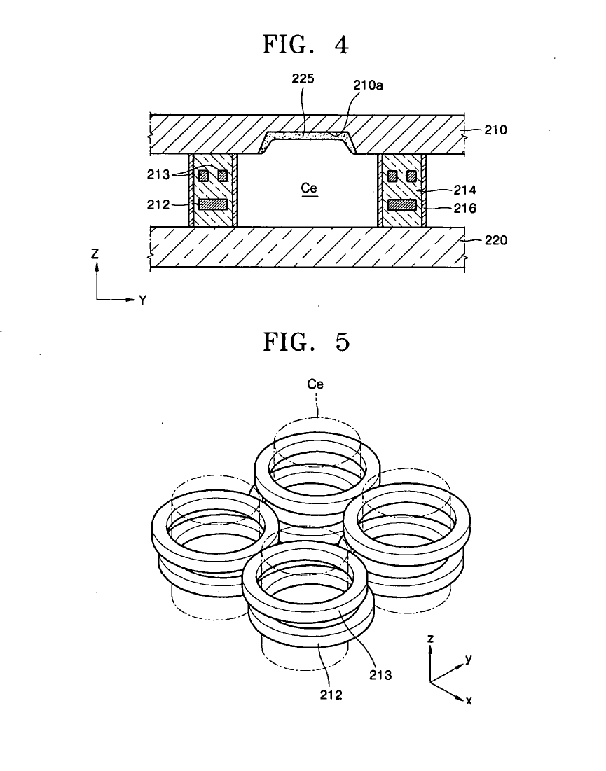

FIG. 3 is a perspective view of a plasma display panel (PDP) 200 having improved light-emitting efficiency and reduced likelihood of a permanent afterimage or long-time image retention, which uses a method of driving the PDP according to an embodiment of the present invention. FIG. 4 is a cross-sectional view of the PDP of FIG. 3 taken along line IV-IV in FIG. 3. FIG. 5 illustrates discharge cells and electrodes illustrated in FIGS. 3 and 4.

Referring to FIGS. 3 through 5, the PDP 200 includes a first substrate 210, a second substrate 220, a barrier rib 214, a first electrode 212, a second electrode 213, a phosphor layer 225, a protection layer 216, and a discharge gas (not shown).

The first and second substrates 210 and 220 are spaced apart from each other. In one embodiment, the barrier rib 214 may be formed in a body illustrated in the drawings, or be divided into a front barrier rib and a rear barrier rib that are attached to the first and second substrates 210 and 220, respectively. The barrier rib 214 along with the first and second substrates 210 and 220 partitions the discharge cell Ce that is a space for performing a discharge. In one embodiment, the discharge cells Ce may be formed in an aperture having a circular cross-section in the barrier rib 214. In another embodiment, the discharge cells Ce may have triangular, rectangular, pentagonal, or oval cross-sections. In one embodiment, the barrier rib 214 may partition the discharge cells Ce in the form of a matrix. If the barrier rib 214 forms a plurality of discharge spaces, the discharge cells Ce may be partitioned in a variety of patterns such as a waffle pattern or a delta pattern, etc. The barrier rib 214 is generally formed of a dielectric material.

In one embodiment, the first and second electrodes 212 and 213, spaced apart from each other, are formed in the barrier rib 214. In one embodiment, the first and second electrodes 212 and 213 may surround entirely the discharge cells Ce. In another embodiment, the discharge cells Ce may be partly surrounded by the first and second electrodes 212 and 213. The first and second electrodes 212 and 213 extend in x and y directions, respectively. In one embodiment, the first and second electrodes 212, 213 are sequentially arranged in a direction (a z direction) from the first substrate 210 to the second substrate 220.

In one embodiment, the first protection layer 216, formed of MgO, is arranged in the exterior surface of the barrier rib 214 forming the discharge cells Ce. When a discharge is performed, the first protection layer 216 protects the first and second electrodes 212 and 213, and the barrier rib 214, and discharges a secondary electron, making the discharge easy.

In one embodiment, the phosphor layer 225 is formed on the first substrate 210, and, more specifically, in a groove 210a formed on the first substrate 210 in a direction of the second substrate 220. In another embodiment, the phosphor layer 225 may be formed in a groove (not shown) formed on the second substrate 220 in a direction of the first substrate 210, or be formed on both first and second substrates 210 and 220.

In one embodiment, the discharge gas which is injected into the discharge cells Ce is a mixture of xenon (Xe) under about 10% or over about 10% and one or two out of neon (Ne), helium (He), and argon (Ar).

In one embodiment, the first and second substrates 210 and 220 are formed of an excellent transparent material such as glass. The second substrate 220 is spaced apart from the first substrate 210. In one embodiment, the first and second substrates 210 and 220 are formed of an actually same material. In another embodiment, the first and second substrates 210 and 220 have the same coefficient of thermal expansion.

When the discharge is performed, the barrier rib 214 prevents the first and second electrodes 212 and 213 from electrically connecting to each other, and being damaged due to collisions with charge particles. In one embodiment, the barrier rib 214 is formed of a dielectric material that induces charge particles and accumulates wall charges. The dielectric material may be PbO, B₂O₃, SiO₂, etc.

A predetermined voltage is applied to each of the first and second electrodes 212 and 213 to perform the discharge. In one embodiment, the first and second electrodes 212 and 213 may be formed of highly conductive material such as Ag, Cu, Cr, etc.

In one embodiment, the phosphor layer 225 is formed by coating a phosphor paste including one of a red light-emitting phosphor material, a green light-emitting phosphor material, and a blue light-emitting phosphor material, a solvent, and a binder on the groove 210a formed on the first substrate 210, drying the coated groove, and forming a metal. The red light-emitting phosphor material may be Y(V,P)O₄:Eu, the green light-emitting phosphor material may be Zn₂SiO₄:Mn, YBO₃:Tb, and the blue light-emitting phosphor material may be BAM:Eu.

A second protection layer (not shown) formed of MgO may be formed in the front (a-z direction) of the phosphor layer 225. When the discharge is performed in the discharge cells Ce, the second protection layer prevents the phosphor layer 225 from being deteriorated due to collisions with discharge particles, and discharges the secondary electron, making the discharge easier.

The PDP 200 illustrated in FIGS. 3 through 5 is advantageous to the conventional PDP 1.

First, since the PDP 200 does not require additional dielectric layers for the discharge electrodes 212 and 213, the visible radiation generated by the discharge is directly emitted through the first substrate 210 and/or the second substrate 220, such that the light-emitting efficiency is increased, and a transparent electrode such as ITO is not required.

Second, the first and second electrodes 212 and 213 are formed in the barrier rib 214 and around the discharge cells Ce so that an electric field focuses on the center of the discharge cells Ce. Although the PDP 200 displays an image for a long time, the phosphor layers 225 is not ion-sputtered due to charge particles of the discharge gas, thereby avoiding a permanent afterimage. Also, the discharge is performed in every space of the discharge cells Ce, thereby increasing a response speed and discharge efficiency.

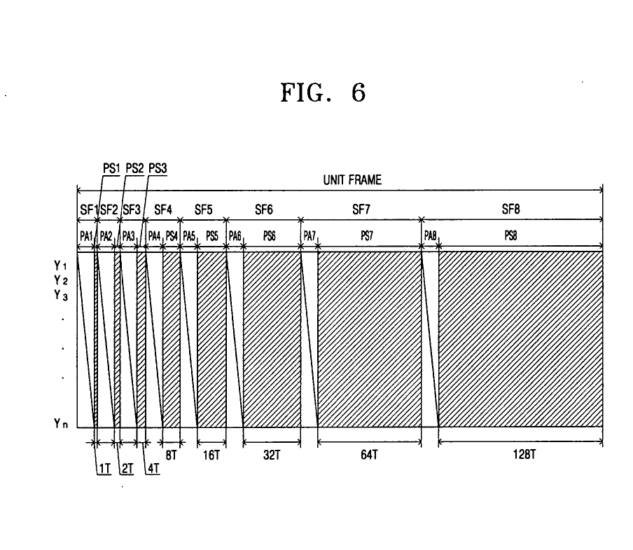

FIG. 6 is a timing diagram for explaining a method of driving the PDP illustrated in FIG. 3. A display image is generally represented by a plurality of unit frames. Referring to FIG. 6, each unit frame is divided into 8 sub-fields SF1 through SF8. Each of the sub-fields SF1 through SF8 is divided into a reset period (not shown in FIG. 6), an address period PA1 through PA8, and a sustain period PS1 through PS8, respectively. The reset period equally initializes all discharge cells, each of the address periods PA1 through PA8 selects a discharge cell that is turned on or off from all discharge cells, and each of the sustain period PS1 through PS8 performs a sustain discharge for a discharge cell selected to be turned on in the address periods PA1 through PA8 according to gray-level weights 1T, 2T, 4T, 8T, 16T, 32T, 64T, and 128T allocated to each of the sub-fields SF1 through SF8. In one embodiment, the PDP 200 is driven using a time-division driving method that applies a driving signal according to the reset period, the address periods PAl through PA8, and the sustain periods PS1 through PS8 of each of the sub-fields SF1 through SF8.

The sub-fields SF1 through SF8, the reset period (not shown), the address period PA1 through PA8, the sustain discharge period PS1 through PS8, and the gray-level weights 1T, 2T, 4T, 8T, 16T, 32T, 64T, and 128T are not necessarily restricted thereto. For example, the number of the sub-fields of the unit frame may be less than or greater than 8, and the allocation of the gray-level weights to the sub-fields may be modified according to an embodiment.

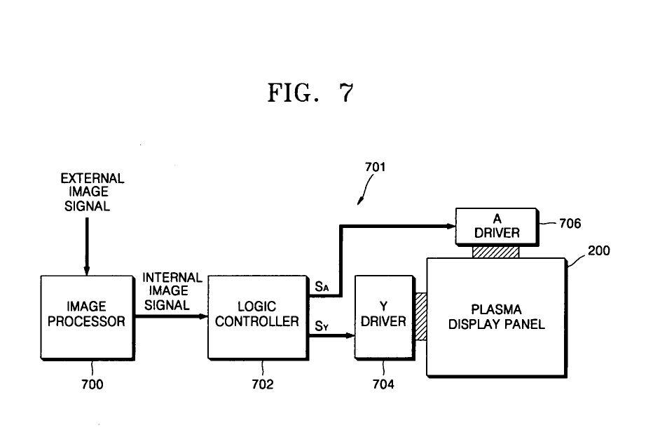

FIG. 7 is a block diagram of the PDP 200 illustrated in FIG. 3 and a plasma display apparatus 701 for driving the PDP according to an embodiment of the present invention. The PDP 200 includes two electrodes which are arranged in the barrier rib 214. Therefore, the plasma display apparatus 701 has a simpler structure than the convention PDP 1 including three electrodes.

Referring to FIG. 7, the plasma display apparatus 701 includes an image processor 700, a logic controller 702, a Y driver 704, an A driver 706, and the PDP 200.

The image processor 700 converts an external analog image signal such as a PC signal, a DVD signal, a video signal, a TV signal, etc. into a digital signal, image-processes the converted digital signal, and outputs an internal image signal. In one embodiment, the internal image signal includes 8-bit red (R), green (G), and blue (B) image data, a clock signal, and vertical and horizontal synchronization signals.

The logic controller 702 outputs a Y driving control signal SY and an A driving control signal SA by processing a gamma correction, an automatic power control (APC) for the internal image signal received from the image processor 700.

The Y driver 704 receives the Y driving control signal SY from the logic controller 702, and applies a driving signal to the first electrode 212. The A driver 706 receives the A driving control signal SA from the logic controller 702, and applies a driving signal to the second electrode 213. Hereinafter the first electrode 212 and the second electrode 213 will be referred to as a Y electrode and an A electrode, respectively.

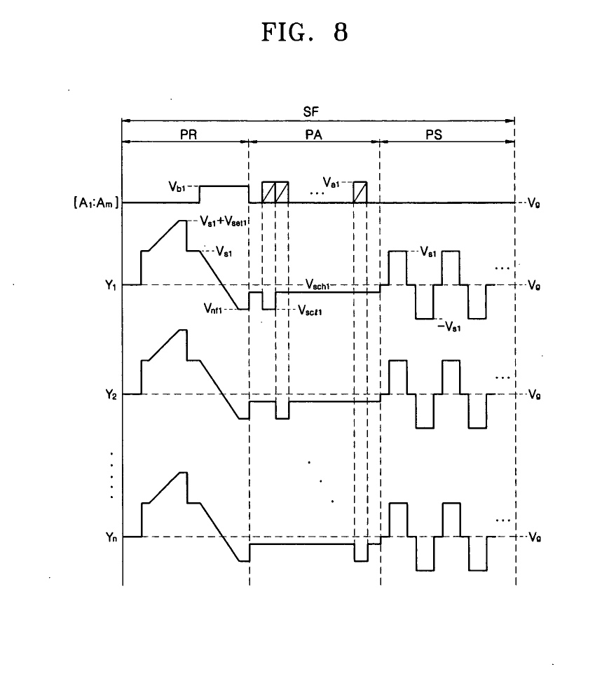

In one embodiment, the Y driver 704 applies a rising pulse and a falling pulse to the Y electrode in the reset period in which the rising pulse and the falling pulse are ramp pulses in order to minimize reset light generated in a reset discharge and precisely control wall charges in discharge cells. In another embodiment, the Y driver 704 applies a reset discharge pulse including at least one monotonically increasing portion and at least one monotonically decreasing portion. This reset pulse can be used in other embodiments. Also, the Y driver 704 applies a plurality of scan pulses sequentially having a high level Vsch1 and a low level Vscl1 to the Y electrode in the address period (see scan pulses applied to Y₁, Y₂, . . . Yn in the address period PA of FIG. 8), and a plurality of sustain pulses each having a high level Vs1 and a low level −Vs1 in the sustain period.

The A driver 706 applies, to the A electrode, a bias voltage Vb1 in the reset period when the falling pulse is applied, a display data signal having a high level Va1 in accordance with the scan pulse in the address period, and an intermediate electric potential Vg between the high level Vs1 and the low level −Vs1 in the sustain period. The address discharge is performed in the address period using the display data signal and the scan pulse (see FIG. 8).

FIG. 8 illustrates waveforms of a driving signal for driving the PDP illustrated in FIG. 3 according to an embodiment of the present invention. Referring to FIGS. 3 through 8, each of the sub-fields SF is divided into a reset period PR, an address period PA, and a sustain period PS.

In the reset period PR, all the discharge cells are initialized. To this end, the state of wall charges in the discharge cells is initialized by a reset discharge in the reset period PR. A variety form of pulses can be applied to the Y electrode to perform the reset discharge. A rectangular pulse was conventionally applied by which an electric potential having a high voltage was rapidly increased, causing a strong discharge in the discharge cells, so that image contrast was deteriorated and the state of wall charges in the discharge cells could not be precisely controlled. In one embodiment of the present invention, ramp pulses or the reset discharge pulse as discussed above are used as the rising pulse and the falling pulse to change the reset discharge into a weak discharge and precisely control the state of wall charges in the discharge cells. That is, a rising ramp pulse and a falling ramp pulse are applied to the Y electrode. In the reset period PR, a low level voltage, for example, a ground voltage Vg, is applied to the A electrode, whereas a bias voltage Vb1 is applied to the A electrode when the falling ramp pulse is applied. The rising ramp pulse rises from a sustain discharge voltage Vs1 to a rising maximum voltage Vs1+Vset1, and the falling ramp pulse falls from the sustain discharge voltage Vs1 to a falling minimum voltage Vnf1. The application of the rising ramp pulse results in accumulating negative wall charges around the Y electrode in the discharge cells, so that the rest discharge is performed between the Y electrode and the A electrode. The application of the falling ramp pulse results in removing the negative wall charges accumulated around the Y electrode in the discharge cells, so that the rest discharge is performed between the Y electrode and the A electrode. The reset discharge initializes the state of the wall charges of the discharge cells so that the state of the wall charges can be suitable for the address discharge performed in the address period PA.

In the address period PA, a discharge cell that is turned on or off is selected from all the discharge cells during the address discharge. Although a write discharge method is used to perform the address discharge in a discharge cell that is turned on with reference to FIG. 8, it is not necessarily restricted thereto. For example, a selective erasure method can be used to perform the address discharge in all the discharge cells, and an erasure method is performed in a discharge cell that is turned off. In the write discharge method, a plurality of scan pulses sequentially having a high level electric potential Vsch1 and a low level electric potential Vscl1 are applied to the Y electrode (see the address period PA of FIG. 8), and the display data signal having a positive electric potential Va1 is applied to the A electrode in accordance with the low level electric potential Vscl1 of the scan pulses. The application of the scan pulses and the display data signal results in performing the address discharge between the Y electrode and the A electrode of the discharge cells. After the address discharge is performed, positive wall charges are accumulated around the Y electrode and negative wall charges are accumulated around the A electrode.

In the sustain period PS, the sustain discharge is performed according to the gray-level weights allocated to the discharge cell that is turned on. A sustain pulse alternately having the high level Vs1 and a low level −Vs1 is applied to the Y electrode, and an intermediate electric potential Vg between the high level Vs1 and the low level −Vs1 of the sustain pulse is applied to the A electrode. A high level electric potential of the sustain pulse is referred to as a sustain discharge voltage Vs1. The number of sustain pulses is proportional to the gray-level weights. That is, a gray-level is changed in proportion to the gray-level weights allocated by the number of sustain discharges. If the sustain pulse of the high level Vs1 is applied to the Y electrode, the sustain discharge is performed by the positive wall charges accumulated around the Y electrode of the discharge cells, the negative wall charges accumulated around the A electrode, the electric potential Vs1 applied to the Y electrode, and the electric potential Vg applied to the A electrode. After the sustain discharge is performed, the positive wall charges and the negative wall charges are accumulated around the A electrode and the Y electrode, respectively. If the sustain pulse of the low level −Vs1 is applied to the Y electrode, the sustain discharge is performed by the negative wall charges accumulated around the Y electrode of the discharge cells, the positive wall charges accumulated around the A electrode, the electric potential −Vs1 applied to the Y electrode, and the electric potential Vg applied to the A electrode. After the sustain discharge is performed, the negative wall charges and the positive wall charges are accumulated around the A electrode and the Y electrode, respectively. Therefore, the sustain discharge is continuously performed according to the number of sustain pulses determined by the gray-level weights.

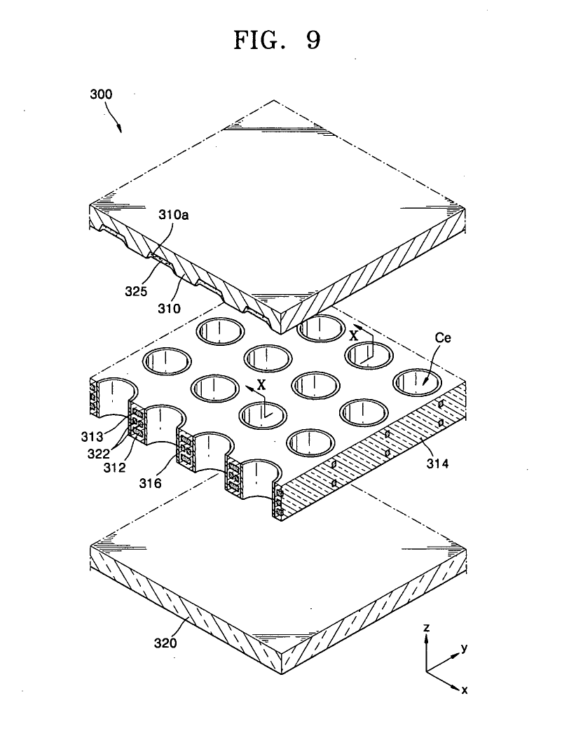

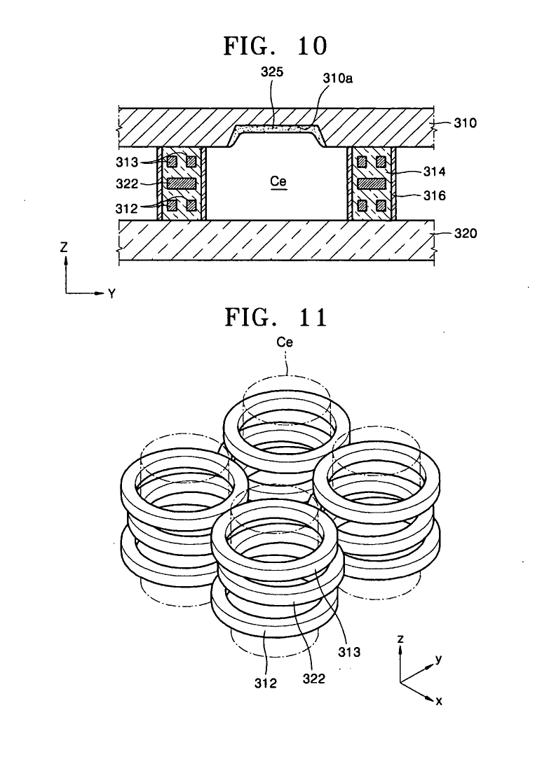

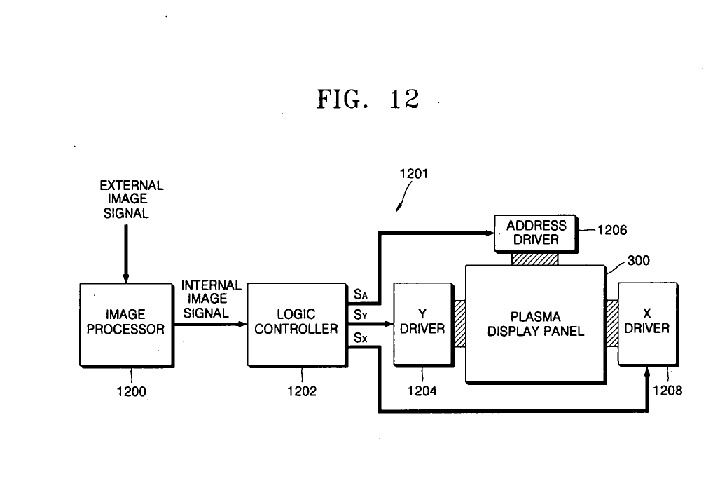

FIG. 9 is a perspective view of a PDP 300 having improved light-emitting efficiency and reduced likelihood of a permanent afterimage, which uses a method of driving the PDP according to another embodiment of the present invention. FIG. 10 is a cross-sectional view of the PDP of FIG. 9 taken along line X-X in FIG. 9. FIG. 11 illustrates discharge cells and electrodes illustrated in FIGS. 9 and 10.

The PDP 300 is similar to the PDP 200 illustrated in FIGS. 3 through 5 except that the PDP 300 includes three electrodes, whereas the PDP 200 includes two electrodes. The difference between the PDP 300 and the PDP 200 will now be described.

Referring to FIGS. 9 through 11, the PDP 300 includes a first substrate 310, a second substrate 320, a barrier rib 314, a first electrode 312, a second electrode 313, a third electrode 322, a phosphor layer 325, a first protection layer 316, and a discharge gas (not shown).

The description of the first substrate 310, the second substrate 320, the barrier rib 314, the phosphor layer 325, the first protection layer 316, and the discharge gas is the same as the description with reference to FIGS. 3 through 5.

In one embodiment, the first, second, and third electrodes 312, 313, and 322, spaced apart from one another, are formed in the barrier rib 314. In one embodiment, the three electrodes 312, 313, and 322 may surround the entire discharge cells Ce. In another embodiment, the discharge cells Ce may be partly surrounded by the first, second, and third electrodes 312, 313, and 322. The first and second electrodes 312 and 313 extend in a direction (for example, an x direction in FIG. 11), and the third electrode 322 extends in a direction (for example, a y direction in FIG. 11) to cross the first and second electrodes 312 and 313. The second electrode 313, the third electrode 322, and the first electrode 312, not necessarily restricted thereto, are sequentially arranged in a direction (a -z direction) from the first substrate 310 to the second substrate 320, and may be differently arranged according to an embodiment.

The PDP 300 illustrated in FIGS. 9 through 11 has the same advantage as the PDP 200 illustrated in FIGS. 3 through 5.

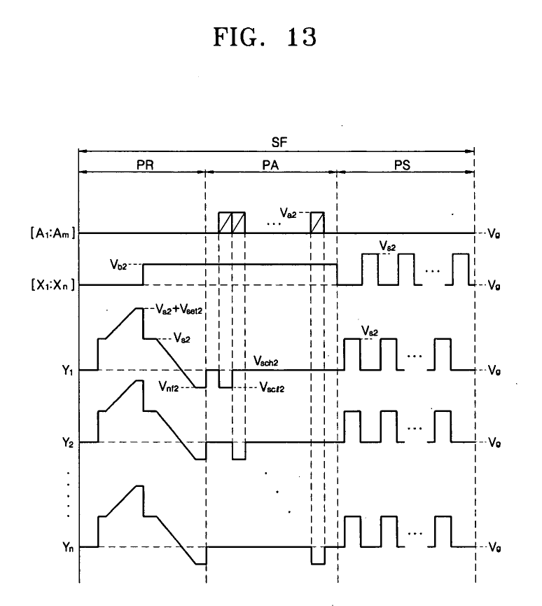

FIG. 12 is a block diagram of the PDP illustrated in FIG. 9 and a plasma display apparatus 1201 for driving the PDP according to another embodiment of the present invention. The plasma display apparatus 1201 illustrated in FIG. 12 is similar to the plasma display apparatus 701. The difference between both plasma display apparatuses will now be described.

Referring to FIGS. 9 through 12, the plasma display apparatus 1201 includes an image processor 1200, a logic controller 1202, a Y driver 1204, an A driver 1206, an X driver 1208, and the PDP 300.

The image processor 1200 performs the same function as the image processor 700.

The logic controller 1202 outputs a Y driving control signal SY, an A driving control signal SA, and an X driving control signal SX by processing, for example, a gamma correction, an automatic power control (APC) for an internal image signal received from the image processor 1200.

The Y driver 1204 receives the Y driving control signal SY from the logic controller 1202, and applies a driving signal to the first electrode 312. The X driver 1208 receives the X driving control signal SX from the logic controller 1202, and applies a driving signal to the second electrode 313. The A driver 1206 receives the A driving control signal SA from the logic controller 1202, and applies a driving signal to the third electrode 322. Hereinafter the first electrode 312, the second electrode 313, and the third electrode 322 will now be referred to as a Y electrode, an X electrode, and an A electrode, respectively.

The Y driver 1204 applies a rising pulse and a falling pulse to the Y electrode in the reset period in which the rising pulse and the falling pulse are ramp pulses. Also, the Y driver 704 applies a plurality of scan pulses sequentially having a high level Vsch1 and a low level Vscl1 to the Y electrode in the address period, and a plurality of sustain pulses each having a high level Vs1 and a low level −Vs1 in the sustain period. In one embodiment, the rising pulse and the falling pulse are ramp pulses in order to perform the reset discharge as a weak discharge other than a strong discharge and precisely control wall charges in discharge cells.

The X driver 1208 applies the bias voltage Vb2 to the X electrode between the reset period in which the falling pulse is applied and the address period, and the sustain pulse in the sustain period. The sustain pulses output by the Y driver 1204 and the X driver 1208 alternates, thereby performing the sustain discharge in the discharge cells.

The A driver 1206 applies a display data signal to the A electrode in the address period in accordance with the scan pulse. The address discharge is performed in the address period using the display data signal and the scan pulse. The A driver 1206 applies a low level electric potential Vg to the A electrode in the sustain period.

FIG. 13 illustrates waveforms of a driving signal for driving the PDP illustrated in FIG. 9 according to another embodiment of the present invention. The method described in FIG. 9 uses a time division gray level image representation as illustrated in FIG. 6. The driving signal of FIG. 13 is similar to the driving signal of FIG. 8. The difference between both driving signals will now be described.

Referring to FIGS. 9 through 13, each of the sub-fields SF is divided into a reset period PR, an address period PA, and a sustain period PS.

In the reset period PR, a low level voltage, for example, a ground voltage Vg, is applied to the A electrode, whereas a bias voltage Vb1 is applied to the A electrode when the falling ramp pulse is applied, and the ground voltage Vg is applied to the A electrode.

The rising ramp pulse rises from a sustain discharge voltage Vs2 to a rising maximum voltage Vs2+Vset2, and the falling ramp pulse falls from the sustain discharge voltage Vs2 to a falling minimum voltage Vnf2. The application of the rising ramp pulse results in accumulating negative wall charges around the Y electrode in the discharge cells, so that the rest discharge is performed between the Y electrode and the A electrode and between the Y electrode and the X electrode. The application of the falling ramp pulse results in the erasure of the negative wall charges accumulated around the Y electrode in the discharge cells, so that the rest discharge is performed between the Y electrode and the A electrode and between the Y electrode and the X electrode. The reset discharge initializes the state of the wall charges of the discharge cells so that the state of the wall charges can be suitable for the address discharge performed in the address period PA.

In the address period PA, a discharge cell that is turned on or off is selected from all the discharge cells during the address discharge. Although a write discharge method is used to perform the address discharge in a discharge cell that is turned on with reference to FIG. 8, it is not necessarily restricted thereto. In one embodiment, a selective erasure method is used to perform the address discharge in all the discharge cells, and an erasure method is performed in a discharge cell that is turned off. In the write discharge method, a scan pulse sequentially having a high level electric potential Vsch2 and a low level electric potential Vscl2 is applied to the Y electrode (see the address period PA in FIG. 13), and the display data signal having a positive electric potential Va2 is applied to the A electrode in accordance with the low level electric potential Vscl2 of the scan pulse, and the bias voltage Vb2 is continuously applied to the X electrode. The application of the scan pulse and the display data signal results in performing the address discharge between the Y electrode and the A electrode of the discharge cells. After the address discharge is performed, positive wall charges are accumulated around the Y electrode, negative wall charges are accumulated around the A electrode, and negative wall charges are accumulated around the X electrode.

In the sustain period PS, the sustain discharge is performed according to the gray-level weights allocated to the discharge cell that is turned on. A sustain pulse alternately having the high level Vs2 and a low level Vg is applied to the Y electrode and the X electrode, and an intermediate electric potential Vg between the high level Vs2 and the low level Vg of the sustain pulse is applied to the A electrode. A high level electric potential of the sustain pulse is referred to as a sustain discharge voltage Vs2. The number of sustain pulses is proportional to the gray-level weights. That is, a gray-level is changed in proportion to the gray-level weights allocated by the number of sustain discharges. If the sustain pulse of the high level Vs2 is applied to the Y electrode, the sustain discharge is performed by the positive wall charges accumulated around the Y electrode of the discharge cells, the negative wall charges accumulated around the X electrode, the electric potential Vs2 applied to the Y electrode, and the electric potential Vg applied to the X electrode. After the sustain discharge is performed, the positive wall charges and the negative wall charges are accumulated around the X electrode and the Y electrode, respectively. If the sustain pulse of the high level electric potential Vs2 is applied to the X electrode, the sustain discharge is performed by the negative wall charges accumulated around the Y electrode of the discharge cells, the positive wall charges accumulated around the A electrode, the electric potential Vg applied to the Y electrode, and the electric potential Vs2 applied to the X electrode. After the sustain discharge is performed, the negative wall charges and the positive wall charges are accumulated around the X electrode and the Y electrode, respectively. Therefore, the sustain discharge is continuously performed according to the number of sustain pulses determined by the gray-level weights.

As described above, the PDP having a new structure according to the present invention improves light-emitting efficiency and reduces the likelihood of a permanent afterimage.

According to one embodiment of the present invention, since a rising pulse and a falling pulse are applied as ramp pulses in a reset period, a reset discharge is performed as a weak discharge and wall charges in discharge cells are precisely controlled.

While the reset discharge is conventionally performed as a strong discharge due to a rectangular pulse, image contrast of the PDP according to one embodiment of the present invention is improved.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of driving a plasma display panel (PDP) including first and second substrates spaced apart from each other, a barrier rib along with the first and second substrates partitioning discharge cells that are discharge spaces, first and second electrodes extending to cross each other in the barrier rib, a phosphor layer formed in the discharge cells, and a discharge gas retained by the discharge cells, the method comprising:
applying a rising ramp pulse and a falling ramp pulse to the first electrode during a reset period so as to initialize all discharge cells;
performing an address discharge during an address period so as to select a discharge cell that is turned on or off; and
performing a sustain discharge during a sustain period for a discharge cell selected to be turned on during the address period,
wherein a display image is represented by a plurality of unit frames and each unit frame is divided into a plurality of sub-fields, and wherein each of the sub-fields includes, in order, the reset period, the address period and the sustain period.

2. The method of claim 1, further comprising applying a bias voltage to the second electrode when the falling pulse is applied during the reset period.

3. The method of claim 1, further comprising i) applying a plurality of low level scan pulses to the first electrode, wherein the low level scan pulses are sequentially provided during the address period and ii) applying a display data signal to the second electrode in accordance with the plurality of low level scan pulses in the address period.

4. The method of claim 1, further comprising i) applying a sustain pulse alternately having a high level and a low level to the first electrode, and ii) applying a pulse having an intermediate level between the high level and the low level of the sustain pulse to the second electrode in the sustain period.

5. A method of driving a PDP including first and second substrates spaced apart from each other, a barrier rib along with the first and second substrates partitioning discharge cells that are discharge spaces, first and second electrodes extending in a direction in the barrier rib, a third electrode extending to cross the first and second electrodes in the barrier rib, a phosphor layer formed in the discharge cells, and a discharge gas retained by the discharge cells, the method comprising:
applying a reset discharge pulse, including at least one monotonically increasing portion and at least one monotonically decreasing portion, to the first electrode, during a reset period, so as to initialize all discharge cells;
performing an address discharge, during an address period, so as to select a discharge cell that is turned on or off; and
performing a sustain discharge, during a sustain period, for a discharge cell selected to be turned on during the address period,
wherein a display image is represented by a plurality of unit frames and each unit frame is divided into a plurality of sub-fields, and wherein each of the sub-fields includes, in order, the reset period, the address period and the sustain period.

6. The method of claim 5, further comprising applying a bias voltage to the second electrode when the falling pulse is applied in the reset period.

7. The method of claim 5, further comprising i) applying a plurality of low level scan pulses to the first electrode, wherein the low level scan pulses are sequentially provided during the address period, ii) applying a display data signal to the third electrode in accordance with the plurality of low level scan pulses, and iii) applying a bias voltage to the second electrode in the address period.

8. The method of claim 5, further comprising i) applying a sustain pulse alternately having a high level and a low level to the first electrode and the second electrode, and ii) applying a pulse having an intermediate level between the high level and the low level of the sustain pulse to the third electrode in the sustain period.

9. A plasma display apparatus, comprising:
a plasma display panel (PDP) including i) first and second substrates spaced apart from each other, ii) a barrier rib along with the first and second substrates partitioning discharge cells that are discharge spaces, iii) first and second electrodes extending to cross each other in the barrier rib, iv) a phosphor layer formed in the discharge cells and v) a discharge gas in the discharge cells; and
drivers configured to apply diving signals in reset, address, and sustain periods to the first and second electrodes, respectively, so as to drive the PDP, wherein a display image is represented by a plurality of unit frames, and each unit frame is divided into a plurality of sub-fields, and wherein each of the sub-fields includes the reset period when all discharge cells are initialized, the address period when a discharge cell that is turned on or off is selected from all discharge cells, and the sustain period when a sustain discharge is performed for a discharge cell selected to be turned on in the address period according to gray-level weights allocated to each of the sub-fields,
wherein the drivers include a first driver configured to apply a first driving signal to the first electrode, and a second driver configured to apply a second driving signal to the second electrode,
and wherein the first driver is configured to apply a rising ramp pulse and a falling ramp pulse to the first electrode in the reset period.

10. The plasma display apparatus of claim 9, wherein the second driver is further configured to apply a bias voltage to the second electrode when the first driver applies the falling ramp pulse to the first electrode in the reset period.

11. The plasma display apparatus of claim 9, wherein the first driver is further configured to apply a plurality of scan pulses each including a low level to the first electrode, wherein the low level scan pulses are sequentially provided during the address period and the second driver is further configured to apply a display data signal to the second electrode in accordance with the plurality of scan pulses in the address period.

12. The plasma display apparatus of claim 9, wherein the first driver is further configured to apply a sustain pulse alternately having a high level and a low level to the first electrode, and the second driver is further configured to apply an intermediate level pulse between the high level and the low level of the sustain pulse to the second electrode in the sustain period.

13. A plasma display apparatus, comprising:
a plasma display panel (PDP) including i) first and second substrates spaced apart from each other, ii) a barrier rib along with the first and second substrates partitioning discharge cells that are discharge spaces, iii) first and second electrodes extending in a direction in the barrier rib, iv) a third electrode extending to cross the first and second electrodes in the barrier rib, v) a phosphor layer formed in the discharge cells and vi) a discharge gas in the discharge cells; and
drivers configured to apply diving signals in reset, address, and sustain periods to the first, second, and third electrodes, respectively, so as to drive the PDP, wherein a display image is represented by a plurality of unit frames, and each unit frame is divided into a plurality of sub-fields, and wherein each of the sub-fields includes the reset period when all discharge cells are initialized, the address period when a discharge cell that is turned on or off is selected from all discharge cells, and the sustain period when a sustain discharge is performed for a discharge cell selected to be turned on in the address period according to gray-level weights allocated to each of the sub-fields,
wherein the drivers include a first driver configured to apply a first driving signal to the first electrode, a second driver configured to apply a second driving signal to the second electrode, and a third driver configured to apply a third driving signal to the third electrode,
and wherein the first driver is further configured to apply a reset discharge pulse, including at least one monotonically increasing portion and at least one monotonically decreasing portion, to the first electrode in the reset period.

14. The plasma display apparatus of claim 13, wherein the second driver is further configured to apply a bias voltage to the second electrode when the at least monotonically decreasing portion of the reset discharge pulse is applied in the reset period.

15. The plasma display apparatus of claim 13, wherein the first driver is further configured to apply a plurality of scan pulses each including a low level to the first electrode, wherein the low level scan pulses are sequentially provided during the address period, wherein the third driver is further configured to apply a display data signal to the third electrode in accordance with the plurality of scan pulses, and wherein the second driver is further configured to apply a bias voltage to the second electrode in the address period.

16. The plasma display apparatus of claim 13, wherein the first and second drivers are further configured to apply a sustain pulse alternately having a high level and a low level to the first and second electrodes, respectively, and the third electrode is further configured to apply an intermediate level pulse between the high level and the low level of the sustain pulse to the third electrode in the sustain period.

17. The method of claim 1, wherein the sustain discharge is performed according to gray-level weights assigned to each of the sub-fields

18. The method of claim 5, wherein the sustain discharge is performed according to gray-level weights allocated to each of the sub-fields

19. The method of claim 5, wherein the reset discharge pulse includes at least one ramp pulse.

20. The plasma display apparatus of claim 13, wherein the reset discharge pulse includes at least one ramp pulse.
